(19) United States
(12) Patent Application Publication
(10) Pub. No.: US 2023/0387389 A1
(43) Pub. Date: Nov. 30, 2023

(54) DEGRADATION-RESISTANT COATING FOR CATHODES

(71) Applicant: Rivian IP Holdings, LLC, Irvine, CA (US)

(72) Inventors: Soo Kim, Fremont, CA (US); Tae Kyoung Kim, Sunnyvale, CA (US); Ki Tae Park, Santa Clara, CA (US)

(21) Appl. No.: 17/827,173

(22) Filed: May 27, 2022

(51) Int. Cl. H01M 4/36; H01M 4/485; H01M 4/505; H01M 4/525; H01M 10/0525; H01M 4/04; H01M 4/58

(52) U.S. Cl. CPC H01M 4/366; H01M 4/485; H01M 4/505; H01M 4/525; H01M 10/0525; H01M 4/0404; H01M 4/5825; H01M 2004/028

(57) ABSTRACT

This disclosure is generally directed to coating materials for cathode active materials for lithium ion batteries (LIBs) and the methods used to identify such coating materials. The coatings are lithium transition metal phosphorous oxide materials (Li-M-P-O) that are stable to cycling with cathode active materials having a layered-type structure such as lithium nickel-manganese-cobalt oxide materials and they are reactive with battery degradation materials (i.e., HF, PF₅⁻, etc.) to scavenge those materials from the electrolyte. The coating materials may also be applied to current collectors, or other internal components of the LIB. Exemplary specific materials identified as having desirable properties are: LiMnPO₄, LiCoPO₄, LiNiPO₄, LiSnPO₄, LiV(PO₃)₄, LiCrP₂O₇, Li₃Mn₃(PO₄)₄, Li₂MnP₂O₇, Li₂FeP₂O₇, and LiCo(PO₃)₃; also identified were combinations of such materials with LiFePO₄.

### INTRODUCTION

The present technology is generally related to lithium rechargeable batteries. More particularly the technology relates to coating materials for secondary rechargeable batteries, such as lithium ion batteries (LIBs).

It has now been found that lithium transition metal phosphorus oxide (Li-M-P-O) materials may be used as coating materials on the surface of cathode active materials or on other components in lithium ion batteries (LIBs). The coatings are ionically conductive while being electronically insulating, and they can protect the underlying cathode active material from reaction with more conventional coating materials or electrolyte degradation products. Accordingly, the present disclosure provides for coatings based upon such lithium transition metal phosphorus oxides, methods for the preparation, and methods for their incorporation into LIBs.

### SUMMARY

One of the most common methods to prevent battery degradation, especially on the cathode side that experiences high voltage, is to utilize a protective coating. Typically, oxide type coatings are used to withstand the harsh, unexpected operating conditions of the LIBs. Three major roles of coatings are: 1) formation of modified cathode electrolyte interface (CEI), which help stabilize the interface between electrode and electrolyte, in particular in the event of electrolyte decomposition; 2) improves the electrolyte wetting to ensure uniform Li⁺ ion (de-)insertion; and, 3) suppress surface phase transition of cathode material (i.e., surface decomposition) as a physical barrier.

The present technology addresses the current need for oxide coatings with properties superior to the current state of the art. Lithium transition metal phosphorus oxide (“Li-M-P-O”) coatings provide help with thermal and electrochemical stability when applied to high Ni cathode materials. Li-M-P-O coatings also improve performance of LIBs by scavenging problematic compounds such as HF and PF₅⁻ while simultaneously being stable with nickel-rich cathodes.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

FIG. 1 shows the chemical reaction between LiFePO₄ and NMC811. The x-axis shows the molar fraction of LiFePO₄, where x=0 is 100% NMC811 and x=1 is 100% LiFePO₄. The y-axis describes the reaction enthalpy in eV/atom.

FIG. 2 is a schematic illustration of various embodiments of the cathode compositions of the present technology that include a discontinuous coating, as discussed in the present disclosure.

FIG. 3 is a schematic illustration of various embodiments of the cathode compositions of the present technology that include a first coating material and a second coating material, as discussed in the present disclosure.

FIG. 4 is a schematic, non-limiting illustration of a Li-M-P-O crystal structure that may be included in a coating of the present technology, according to various embodiments.

FIG. 5 is an illustration of a cross-sectional view of an electric vehicle, according to various embodiments.

FIG. 6 is a depiction of an illustrative battery pack, according to various embodiments.

FIG. 7 is a depiction of an illustrative battery module, according to various embodiments.

FIGS. 8, 9, and 10 are cross sectional illustrations of various batteries, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The phrase “and/or” as used in the present disclosure will be understood to mean any one of the recited members individually or a combination of any two or more thereof—for example, “A, B, and/or C” would mean “A, B, C, A and B, A and C, B and C, or the combination of A, B, and C.”

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

One option to prevent degradation in lithium ion batteries (“LIBs”) is to utilize a protective coating on the electroactive species, particularly with regard to the cathode active materials used in the batteries. Typically, metal oxide-type coatings are used to withstand the harsh operating conditions within the LIBs. Cathode decomposition may occur during the structural phase transition (i.e., where lithium ions (de-)insert from the electrode material) and/or when in contact with other components of the LIBs, such as the electrolytes and current collectors. Illustrative commercially available cathode active materials include, but are not limited to, LiCoO₂, Li(NiₐMn_{b}Co_{c})O₂ (also referred to as LiNMC materials), Li(NiₐCo_{b}Al_{c})O₂ (also referred to as LiNCA materials), Li(Ni_{d}CoₑMn_{f}Al_{g})O₂ (also referred to as LiNCMA materials), and Li(Mn_{α}Ni_{β})₂O₄, where a+b+c=1, d+e+f+g=1 and α+β=1. Coatings on such cathode active material provide for: 1) formation of a modified solid electrolyte interface (SEI) and/or cathode electrolyte interface (CEI), which helps stabilize the interface between the electrode and electrolyte; 2) improvements in electrolyte wetting to ensure uniform Li′ ion insertion and de-insertion; and, 3) suppression of surface phase transitions of cathode material (i.e., surface decomposition) as a physical barrier.

LiNMC materials can operate at high voltage—e.g. above 4 V vs. Li/Li′. At such high voltages, especially during the first cycle charge cell formation step, electrolyte decomposition is prevalent, typically starting at about 4.2 V vs. Li/Li⁺. Al₂O₃ has been one of the more studied binary oxide coatings that have been utilized in LIBs. From a cell cycling perspective, it is beneficial to incorporate Al₂O₃ or other binary metal oxide materials as electrode coating materials. However, it has now been found that when applied to LiNMC, the Al₂O₃ consumes Li ions and undergoes a phase transition. For example, when Ni-rich LiNi_{0.8}Mn_{0.1}Co_{0.1}O₂ (NMC811) cathode active material reacts with a Al₂O₃ coating, the following reaction takes place:

0.319 LiNi_{0.8}Mn_{0.1}Co_{0.1}O₂+0.681 Al₂O₃→0.082 Ni₃O₄+0.006 Li₄MnCo₅O₁₂+0.003 LiO₈+0.273 LiAl₅O₈+0.008 Li₂Mn₃NiO₈

This reaction exhibits an enthalpy (Eᵣₓₙ) of −0.033 eV/atom. It is evident that Al₂O₃ is not consumed upon activation, but it causes the NMC811 cathode material to decompose. However, it has now been found that if particular Li-M-P-O compounds (described herein) are used as part of the coating, it is stable when in contact with NMC811. Accordingly, the present technology provides for coatings based upon such lithium transition metal phosphorus oxides (“Li-M-P-Os”) as well as their incorporation into LIBs.

Thus, in an aspect, an electrode composition is provided that includes a lithium transition metal phosphorous oxide (Li-M-P-O) coating on at least a portion of a surface of a particulate bulk cathode active material, wherein the particulate bulk cathode active material has a layered-type structure. In any embodiment herein, the coating may include a lithium transition metal phosphorous oxide other than LiFePO₄. In any embodiment herein, the lithium transition metal phosphorous oxide may have an olivine-type structure and/or the coating may include an olivine-type structure. Crystal structures of cathode active materials and/or coatings may be classified by lithium ion mobility through a 2-D framework (layered-type structure), a 3-D framework (spinel-type structure), and a 1-D framework (olivine-type structure). The structural classification may correspond to thermal stability, ion diffusion pathways, and/or activation energy that may govern lithium ion transport in the electrode. A layered-type structure may be characterized as a two-dimensional lithium ion transport and an olivine-type structure may be characterized as uni-dimensional lithium ion transport. In any embodiment herein, the Li-M-P-O coating may include one or more of the following: a greater NMC811 stability score when normalized to that of LiFePO₄ at 100%, or a greater PF₅⁻ score when normalized to that of LiFePO₄ at 100%, or a greater HF score when normalized to that of LiFePO₄ at 100%, or a lower LiF score when normalized to that of LiMnPO₄ at 100%, or a greater LiOH score when normalized to that of LiFePO₄ at 100%. Thus, the coatings described herein provide equivalent or superior protection to that of LiFePO₄.

As used herein, the NMC811 stability, HF, PF₅⁻, LiF, and LiOH scores are determined based upon the model reaction that is to be run, as discussed in the working examples. For example, the molar ratio of components (HF or PF₅) to Li-M-P-O is first determined (ratio 1). The ratio is then normalized to the ratio for the baseline reaction of LiFePO₄ by dividing ratio 1 (for LiFePO₄) by ratio 1 (for the Li-M-P-O of interest) to arrive at value 2. The enthalpy of reaction (Eᵣₓₙ) in eV/atom is then determined from the calculation, however this is then normalized to the Eᵣₓₙ for LiFePO₄ dividing the Eᵣₓₙ (for the Li-M-P-O of interest) by Eᵣₓₙ (for LiFePO₄) to arrive at value 2. Value 1 and 2 are then summed, however they are based upon molar ratios. To convert the values to weight-based values, the sum is then divided by the molecular weight of the Li-M-P-O multiplied by 1000. The PF₅⁻ or HF score is then determined by dividing the per weight value for the LiFePO₄ by the per weight value of the Li-M-P-O multiplied by 100. Expressed another way, the PF₅⁻ or HF score is a percentage improvement (or diminution) for that reaction compared to the baseline LiFePO₄ value. Illustrative calculations are shown in the examples.

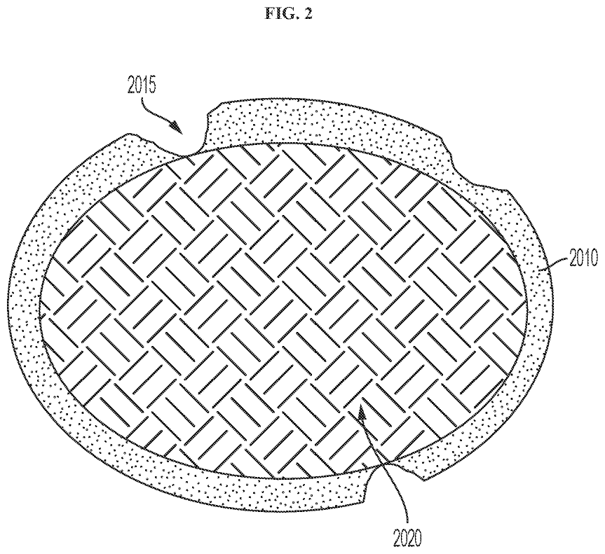

In some embodiments, the lithium transition metal phosphorous oxide includes LiMnPO₄, LiCoPO₄, LiNiPO₄, LiSnPO₄, LiV(PO₃)₄, LiCrP₂O₇, Li₃Mn₃(PO₄)₄, Li₂MnP₂O₇, Li₂FeP₂O₇, LiCo(PO₃)₃, or a mixture of any two or more thereof. In some embodiments, the lithium transition metal phosphorous oxide includes LiCoPO₄, LiNiPO₄, LiSnPO₄, LiCrP₂O₇, Li₃Mn₃(PO₄)₄, Li₂MnP₂O₇, Li₂FeP₂O₇, LiCo(PO₃)₃, or a mixture of any two or more thereof. In some embodiments, the lithium transition metal phosphorous oxide includes LiCoPO₄, LiSnPO₄, Li₃Mn₃(PO₄)₄, or a mixture of any two or more thereof. In any embodiment herein, the lithium transition metal phosphorus oxide may also include LiFePO₄ in addition to one or more lithium transition metal phosphorus oxides that are not LiFePO₄. Such coating materials of any embodiment herein are used at a level sufficient to provide additional protection to the cathode material. For example, this may include where the lithium transition metal phosphorous oxide is present from about 0.01 wt % to about 5.0 wt % of the electrode composition. The thickness of the coating may also play in role in durability, but it may also be a hindrance to current flow. Accordingly, the coating may have an average thickness on the particulate bulk cathode active material of about 5 nm to about 2 nm. In any embodiment herein, the coating may be continuous or discontinuous. Referring to FIG. 2, in some embodiments the coating 2010 may include discontinuous regions 2015 of coating on the particulate bulk cathode active material 2020. It is understood that in the commercial coating of the particulate bulk cathode active materials, commercial coating materials may include voids and other irregularities on the surface of the particulate bulk cathode active material. As the coating material is deposited onto the particulate bulk cathode active material, it may nucleate near grain boundaries of the particulate bulk cathode active material.

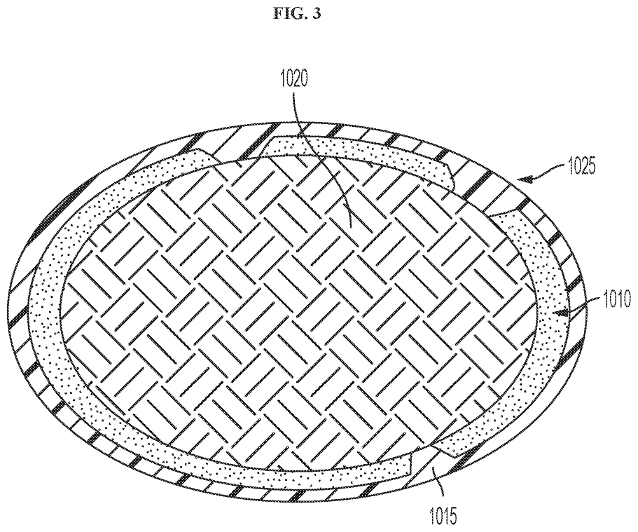

Referring to FIG. 3, in some embodiments, the coating may include a first coating material 1010 and a second coating material 1025. The first coating material 1010 may include discontinuous regions 1015 of coating on the particulate bulk cathode active material 1020, and where a portion of the second coating material 1025 is formed in the discontinuous regions 1015 of the first coating material. In other embodiments, a portion of the second coating material 1025 is formed in the discontinuous regions 1015 of the first coating material 1010 and has a greater thickness than other portions of the coating formed as an overcoating.

In any of the above embodiments, the second coating material may overcoat the first coating material, fill in voids of the first coating material on the surface of the particulate bulk cathode active material, or both overcoats the first coating material and fill in voids of the first coating material on the surface of the particulate bulk cathode active material, and the second coating material may be different from the first coating material as well as the particulate bulk cathode active material. The particulate bulk cathode active material may be a single crystal, polycrystalline, or blended (e.g., different size of single crystals, polycrystals, or mixture of single- and polycrystals), where the first and/or second coating material may be different based on the size, morphology, and/or crystallinity.

It is understood that in the commercial coating of the particulate bulk cathode active materials, commercial (e.g., the first) coating materials include voids and other irregularities on the surface of the particulate bulk cathode active material. As the second coating material is deposited onto the particulate bulk cathode active material, they typically nucleate near grain boundaries of the first coating material or the particulate bulk cathode active material. For example, they may deposit on the particulate bulk cathode active material next to the first coating material. They may also then fill the voids or uncoated areas from the first coating deposition and grow in thickness in those areas as the deposition proceeds. Where the second coating material is deposited on top of the first coating material, the second coating material may be thinner. For example, in some embodiments, a thickness of the first and/or second coating material may be about 5 nm to about 2 um. The first coating material may be formed in discontinuous regions on the surface of the particulate bulk cathode active material, and the second coating material, may be formed in the discontinuous regions of the first coating material. A portion of the second coating material formed in the discontinuous regions of the first coating material may have a greater thickness than other portions of the second coating material formed as an overcoating.

In any embodiment including a first coating material and a second coating material, the second coating material may be different from the first coating material and from the particulate bulk cathode active material. In any of the above embodiments, the first coating material may include LiFePO₄ and/or one or more other lithium metal oxide(s); and the second coating material may include includes LiMnPO₄, LiCoPO₄, LiNiPO₄, LiSnPO₄, LiV(PO₃)₄, LiCrP₂O₇, Li₃Mn₃(PO₄)₄, Li₂MnP₂O₇, Li₂FeP₂O₇, LiCo(PO₃)₃, or a mixture of any two or more thereof.

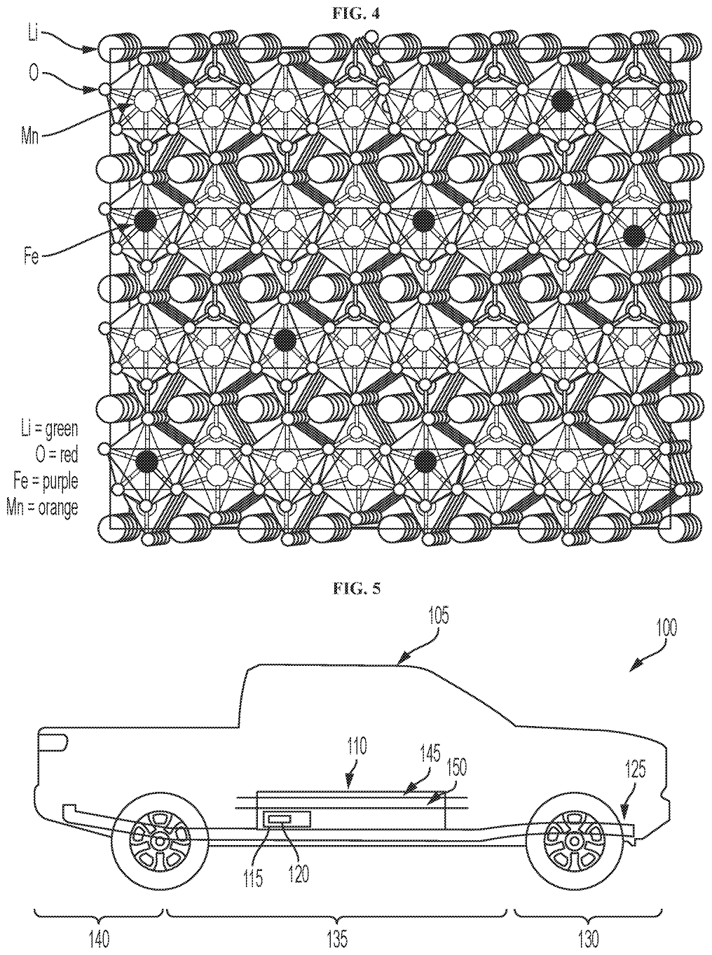

In any embodiment herein, the lithium transition metal phosphorous oxide coating may include a redox voltage greater than 4 V vs. Li/Li′. Such a redox voltage is much higher than LiFePO₄, where particulate olivine-type materials having a redox voltage greater than 4V vs. graphite include but are not limited to—LiCoPO₄, LiNiPO₄, LiSnPO₄, a mixture of any two more thereof, or a mixture of any one or more thereof with LiFePO₄ and/or LiMnPO₄. In any embodiment herein, the lithium transition metal phosphorous oxide coating may include a redox voltage (vs. Li/Li+) greater than LiFePO₄, LiMnPO₄, or a combination of LiFePO₄ and LiMnPO₄. In any embodiment herein, the lithium transition metal phosphorous oxide coating may include LiFePO₄ and a dopant, wherein the dopant increases a de-lithiation voltage of the coating (thus reducing potential de-lithiation) relative to the coating without the dopant. Suitable dopants include, but are not limited to, Co, Si, Sn, Al, Cu, Zn, Ga, Y, Zr, and/or Hf and may provide a material according to the formula LiFe₁₋ₓMₓPO₄ or the formula LiMn₁₋ₓMₓPO₄, where in each formula M is independently Co, Ni, and/or Sn and 0<x<1. In an olivine-type structured lithium transition metal phosphorous oxide, at least a portion of the lithium transition metal phosphorous oxide may be crystalline. FIG. 4 provides an exemplary, non-limiting illustration of a Li-M-P-O crystal structure that may be included in a coating of the present technology. In another embodiment, a portion of lithium transition metal phosphorous oxide may be an amorphous and glassy-like coating.

As noted above, the electrode composition includes a particulate bulk cathode active material having a layered-type structure. As used herein, the particulate bulk cathode active material is the core of a particle that is coated with a thin layer of the lithium transition metal oxide coating on the surface. Generally, the particulate bulk cathode active material may be a nickel-rich cathode active material. Illustrative particulate cathode active materials include materials such as lithium nickel manganese cobalt oxide (“LiNMC”), lithium nickel manganese oxide, lithium cobalt oxide (LCO), LiNCA, LiNCMA, or mixtures of any two or more thereof. In some embodiments, the particulate bulk cathode active material may include Li(NiₐMn_{b}Co_{c})O₂, wherein 0≤a≤1, 0≤b≤1, 0≤c≤1, and a+b+c=1. In some embodiments, the particulate bulk cathode active material may include Li(NiₐMn_{b}Co_{c})O₂, wherein 0<a<1, 0<b<1, 0<c<1, and a+b+c=1. In any embodiment herein, the particulate bulk cathode active material may include LiCoO₂, Li(NiₐMn_{b}Co_{c})O₂, Li(Mn_{α}Ni_{β})₂O₄, or a mixture of any two or more thereof, wherein a+b+c=1, and α+β=1. In any embodiment herein, the particulate bulk cathode active material may include LiCoO₂, Li(NiₐMn_{b}Co_{c})O₂, Li(Mn_{α}Ni_{β})₂O₄, or a mixture of any two or more thereof, wherein 0<a <1, 0<b<1, 0<c<1, a+b+c=1, 0<a<1, 0<β<1, and α+β=1. As used herein nickel-rich cathodes are cathode active materials including 70 wt % or greater of nickel. This may include materials with greater than 80 wt % nickel.

Alternatively, or in addition, to a Li-M-P-O coating on particulate bulk cathode active material, a Li-M-P-O may be coated or deposited on other surfaces within a battery cell or within a battery pouch or within a battery housing where the Li-M-P-O coating may include one or more of the following: a greater NMC811 stability score when normalized to that of LiFePO₄ at 100%, or a greater PF₅⁻ score when normalized to that of LiFePO₄ at 100%, or a greater HF score when normalized to that of LiFePO₄ at 100%, or a lower LiF score when normalized to that of LiMnPO₄ at 100%, or a greater LiOH score when normalized to that of LiFePO₄ at 100%. Accordingly, in other aspects, the Li-M-P-O may be used as a coating on a current collector, on the separator, inside a pouch, or inside a housing, where the Li-M-P-O coating may include one or more of the following: a greater NMC811 stability score when normalized to that of LiFePO₄ at 100%, or a greater PF₅⁻ score when normalized to that of LiFePO₄ at 100%, or a greater HF score when normalized to that of LiFePO₄ at 100%, or a lower LiF score when normalized to that of LiMnPO₄ at 100%, or a greater LiOH score when normalized to that of LiFePO₄ at 100%.

Thus, in another aspect, a current collector includes a metal that is at least partially coated with a lithium transition metal phosphorus oxide (a “Li-M-P-O coating”). In any embodiment herein, it may be that the Li-M-P-O coating includes a lithium transition metal phosphorous oxide other than LiFePO₄. In any embodiment herein, the Li-M-P-O coating may include one or more of the following: a greater NMC811 stability score when normalized to that of LiFePO₄ at 100%, or a greater PF₅⁻ score when normalized to that of LiFePO₄ at 100%, or a greater HF score when normalized to that of LiFePO₄ at 100%, or a lower LiF score when normalized to that of LiMnPO₄ at 100% (e.g., down to 0%), or a greater LiOH score when normalized to that of LiFePO₄ at 100%. In some embodiments, the lithium transition metal phosphorous oxide includes LiMnPO₄, LiCoPO₄, LiNiPO₄, LiSnPO₄, LiV(PO₃)₄, LiCrP₂O₇, Li₃Mn₃(PO₄)₄, Li₂MnP₂O₇, Li₂FeP₂O₇, LiCo(PO₃)₃, or a mixture of any two or more thereof. In some embodiments, the lithium transition metal phosphorous oxide includes LiCoPO₄, LiNiPO₄, LiSnPO₄, LiCrP₂O₇, Li₃Mn₃(PO₄)₄, Li₂MnP₂O₇, Li₂FeP₂O₇, LiCo(PO₃)₃, or a mixture of any two or more thereof. In some embodiments, the lithium transition metal phosphorous oxide includes LiCoPO₄, LiSnPO₄, Li₃Mn₃(PO₄)₄, or a mixture of any two or more thereof. In any embodiment herein, the lithium transition metal phosphorus oxide may also include LiFePO₄ in addition to one or more lithium transition metal phosphorus oxides that are not LiFePO₄.

The current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In some embodiments, the metal foils maybe coated with carbon: e.g., carbon-coated Al foil, and the like.

The materials described herein are all intended for use in electrochemical devices such as, but not limited to, lithium ion batteries. Accordingly, in another aspect, the present technology provides an electrochemical cell, such as a lithium ion battery (e.g., a lithium secondary battery), that includes a cathode including a particulate bulk cathode active material and a current collector and the lithium ion battery also includes a housing. Where the electrochemical cell is a lithium ion battery, the lithium ion battery may also optionally include an anode, a separator, an electrolyte, or a combination of any two or more thereof. The housing may be a pouch in which a battery cell is contained, or it may be the housing the battery in which the pouches are contained. In the lithium ion battery, one or more of the particulate bulk cathode active material, the current collector, or an inner surface of the housing is at least partially coated with a lithium transition metal oxide (a “Li-M-P-O coating”). In any embodiment herein, it may be that the Li-M-P-O coating includes a lithium transition metal phosphorous oxide other than LiFePO₄. In any embodiment herein, the Li-M-P-O coating may include one or more of the following: a greater NMC811 stability score when normalized to that of LiFePO₄ at 100%, or a greater PF₅⁻ score when normalized to that of LiFePO₄ at 100%, or a greater HF score when normalized to that of LiFePO₄ at 100%, or a lower LiF score when normalized to that of LiMnPO₄ at 100% (e.g., down to 0%), or a greater LiOH score when normalized to that of LiFePO₄ at 100%. In some embodiments, the lithium transition metal phosphorous oxide includes LiMnPO₄, LiCoPO₄, LiNiPO₄, LiSnPO₄, LiV(PO₃)₄, LiCrP₂O₇, Li₃Mn₃(PO₄)₄, Li₂MnP₂O₇, Li₂FeP₂O₇, LiCo(PO₃)₃, or a mixture of any two or more thereof. In some embodiments, the lithium transition metal phosphorous oxide includes LiCoPO₄, LiNiPO₄, LiSnPO₄, LiCrP₂O₇, Li₃Mn₃(PO₄)₄, Li₂MnP₂O₇, Li₂FeP₂O₇, LiCo(PO₃)₃, or a mixture of any two or more thereof. In some embodiments, the lithium transition metal phosphorous oxide includes LiCoPO₄, LiSnPO₄, Li₃Mn₃(PO₄)₄, or a mixture of any two or more thereof. In any embodiment herein, the lithium transition metal phosphorus oxide may also include LiFePO₄ in addition to one or more lithium transition metal phosphorus oxides that are not LiFePO₄. In any embodiment herein, the coating may include an average thickness on the particulate bulk cathode active material of about 5 nm to about 2 μm.

The cathodes may include, in addition to a particulate cathode active material of any embodiment herein, one or more of a current collector, a conductive carbon, a binder, or other additives. The anodes of the electrochemical cells may include lithium. In some embodiments, the anodes may also include a current collector, a conductive carbon, a binder, and other additives, as described above with regard to the cathode current collectors, conductive carbon, binders, and other additives. In some embodiments, the electrode may comprise a current collector (e.g., Cu foil) with an in situ-formed anode (e.g., Li metal) on a surface of the current collector facing the separator or solid-state electrolyte such that in an uncharged state, the assembled cell does not comprise an anode active material.

The cathodes and anodes may also each contain, independently of each other, other materials such as conductive carbon materials, current collectors, binders, and other additives. Illustrative conductive carbon species include graphite, carbon black, Super P carbon black material, Ketjen Black, Acetylene Black, SWCNT, MWCNT, graphite, carbon nanofiber, and/or graphene, graphite. Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof. The current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In another embodiment, the metal foils maybe coated with carbon: e.g., carbon-coated Al foil and the like.

In another aspect, a process for manufacturing a cathode for a lithium ion battery is provided. The process includes mixing an electrode composition (of any embodiment of the present technology) with conductive carbon and a binder in a solvent to form a slurry, coating the slurry onto a cathode current collector, and removing the solvent. The loading level of cathode materials on the cathode current collector (after solvent removal) may range from about 5 mg/cm² to about 50 mg/cm², and the packing density may vary from about 1.0 g/cc to about 5.0 g/cc.

Generally, the conductive carbon species may include graphite, carbon black, carbon nanotubes, and the like. Illustrative conductive carbon species include graphite, carbon black, Super P carbon black material, Ketjen Black, Acetylene Black, SWCNT, MWCNT, graphite, carbon nanofiber, and/or graphene, graphite.

Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

The solvent used in the slurry formation may be a ketone, an ether, a heterocyclic ketone, and/or distilled water. One illustrative solvent is N-methylpyrrolidone (“NMP”). The solvent may be removed by allowing the solvent to evaporate at ambient or elevated temperature, or at ambient pressure or reduced pressure. Handling of the cathode and other lithium ion battery internal components may be conducted under an inert atmosphere (N₂, Ar, etc.), under an oxidizing atmosphere (O₂, air, etc.), and/or under a reducing atmosphere (e.g., H₂), according to some embodiments.

In any embodiment herein, a metal-containing precursor chemical including but not limited to metal nitrates, chloride, sulfate, etc., may be dissolved in water or an organic solvent; alternatively, in any embodiment herein, a dry (solventless) mixture may include the metal-containing precursor chemical. In some embodiments, LiOH, (NH₄)₂HPO₄, and/or NH₄F may be added to the solution/dry mixture containing the metal-containing precursor chemical(s). In some embodiments, the solution/dry mixture may be mixed with Li-M-P-O precursors (including carbon coating sources such as sucrose or citric acid) at room temperature or elevated temperature with an aging time varying from 5 min to 24 hours to potentially 1 week. The nominal Li-M-P-O may be targeted to be from about 0.1 wt % to about 5 wt % of the electrode composition. The pH of the solution may be controlled by the presence of acid or base in order to precipitate well-mixed precursor compounds. The mixture may be annealed at elevated temperature may be any of the following values or in a range of any two of the following values: 200° C., 400° C., 600° C., 800° C., and 1,000° C. The aging time may be any of the following values or in a range of any two of the following values: 1, 2, 3, 4, 8, 12, 16, 24, 36, 48, 60 and 72 hours.

In any embodiment herein, variously sized Li-M-P-O coated cathode materials may be synthesized via a solid-state method. The primary particle size range for Li-M-P-O coated cathode materials may any of the following values or in a range of any two of the following values: 30, 40, 50, 60, 70, 80, 90, 100, 110, 120, 130, 140, 150, 160, 170, 180, 190, and 200 nm. In some embodiments, the secondary size range may any of the following values or in a range of any two of the following values: 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, and 20 One exemplary, but not limiting, method of performing solid-state synthesis is a ball-milling process. In some embodiments, the solid-state method may be followed by an optional spray dryer processing step to facilitate the drying and secondary particle formation. The optimal amount of Li-M-P-O and its chemical composition at the electrode material surface may be tuned by the secondary heat-treatment conditions that may be any of the following values or in a range of any two of the following values: 200° C., 400° C., 600° C., 800° C., and 1,000° C. in the presence of an oxidizing gas (e.g., O₂ and/or air), an inert gas (e.g., N₂ and/or Ar), a reducing gas (e.g., H₂), or gas mixture of any two or more thereof.

In other embodiments, Li-M-P-O coating materials may be deposited on the synthesized electrode active materials, as a post-treatment step. Non-limiting examples of deposition techniques include chemical vapor deposition, physical vapor deposition, pulsed laser deposition, emulsion, sol-gel, atomic layer deposition, and/or other deposition techniques. In some embodiments, such as atomic layer deposition, the choice of precursor chemicals may be limited to certain chemical composition as readily appreciated by a person of ordinary skill in the art.

In any embodiment herein, the loading level of cathode materials may vary from about 5 mg/cm² to about 50 mg/cm² and the packing density may vary from about 1.0 g/cc to about 5.0 g/cc. In some embodiments, the electrode may be assembled as the cathode in Li-ion batteries, where the anode materials may be Li metal, graphite, Si, SiOₓ, Si nanowire, lithiated Si, or mixture thereof. In some embodiments, a traditional liquid electrolyte with LiPF₆ salt, dissolved in carbonate solutions may be used. In other embodiments, a solid state electrolyte including but not limited to oxide, sulfide, or phosphates-based crystalline structure may replace the liquid electrolyte. The cell configuration may be prismatic, cylindrical, or pouch type. Each cell can further configure together to design pack, module, or stack with desired power output.

In another aspect, the present disclosure provides a battery pack comprising the electrode composition, the electrochemical cell, and/or the lithium ion battery of any one of the above embodiments. The battery pack may find a wide variety of applications including but are not limited to general energy storage or in vehicles.

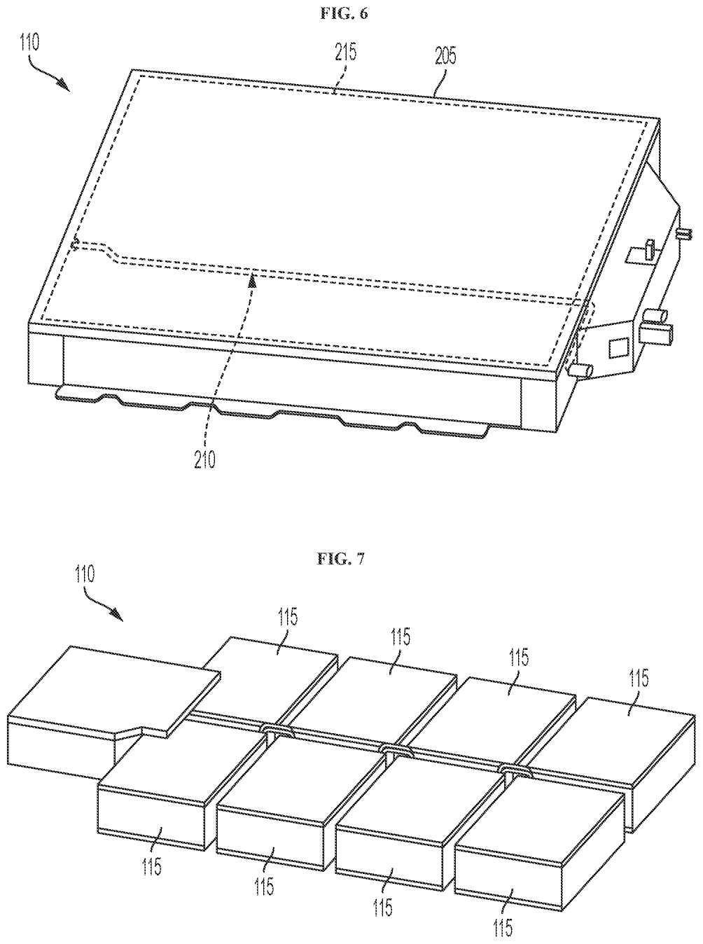

In another aspect, a plurality of battery cells as described above may be used to form a battery and/or a battery pack that may find a wide variety of applications such as general storage, or in vehicles. By way of illustration of the use of such batteries or battery packs in an electric vehicle, FIG. 5 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

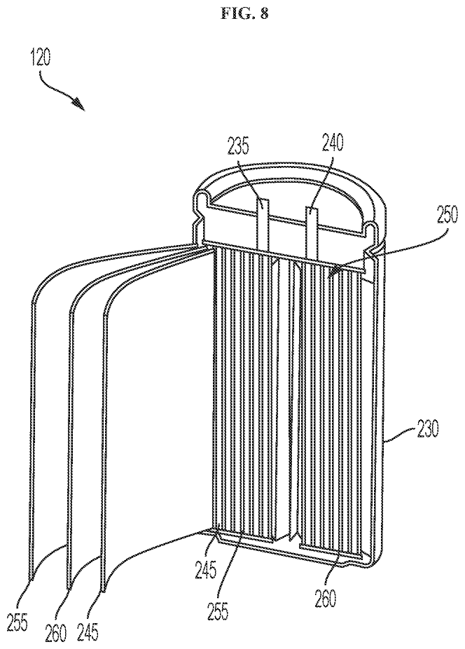

FIG. 6 depicts an example battery pack 110. Referring to FIG. 5 among others, the battery pack 110 can provide power to electric vehicle 105. Battery packs 110 can include any arrangement or network of electrical, electronic, mechanical, or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one cold plate 215. The cold plate 215 can be positioned in relation to a top submodule and a bottom submodule, such as in between the top and bottom submodules, among other possibilities. The battery pack 110 can include any number of cold plates 215. For example, there can be one or more cold plates 215 per battery pack 110, or per battery module 115. At least one cooling line 210 can be coupled with, part of, or independent from the cold plate 215.

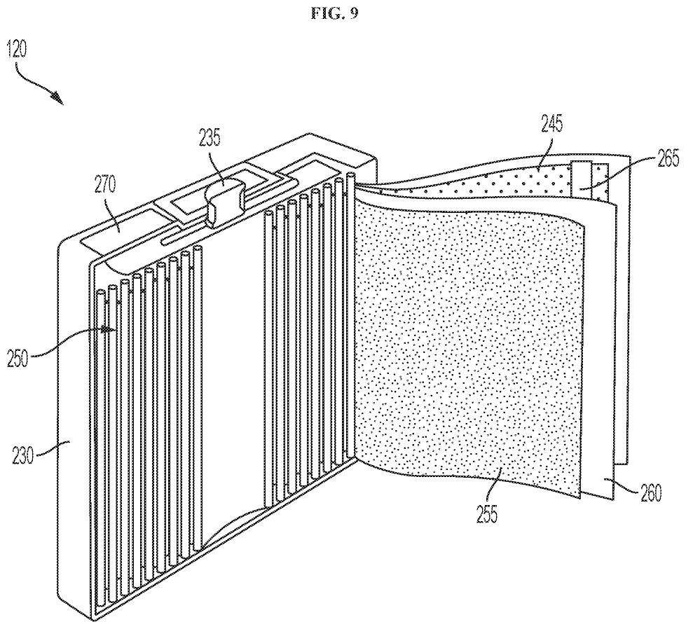

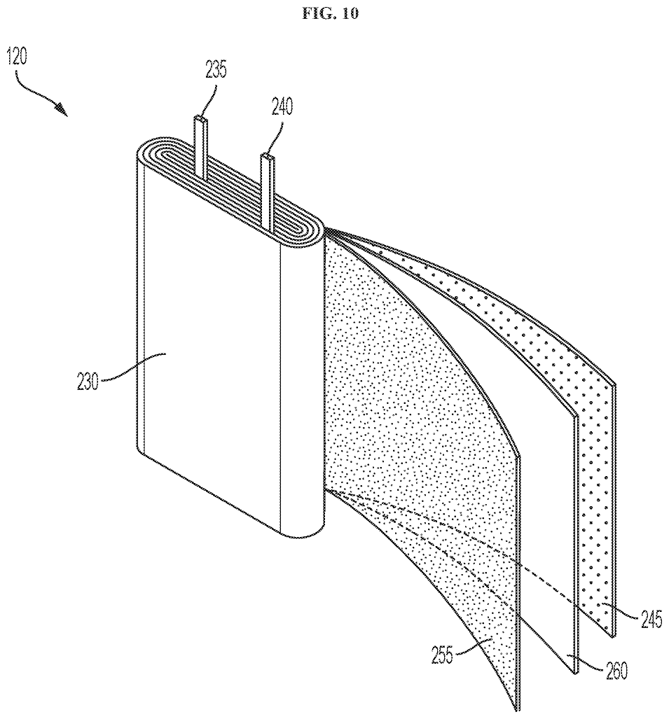

FIG. 7 depicts example battery modules 115, and FIG. 8 depicts an illustrative cross sectional view of a battery cell 120. The battery modules 115 can include at least one submodule. For example, the battery modules 115 can include at least one first (e.g., top) submodule 220 or at least one second (e.g., bottom) submodule 225. At least one cold plate 215 can be disposed between the top submodule 220 and the bottom submodule 225. For example, one cold plate 215 can be configured for heat exchange with one battery module 115. The cold plate 215 can be disposed or thermally coupled between the top submodule 220 and the bottom submodule 225. One cold plate 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells (e.g., FIG. 8) or prismatic cells (e.g., FIG. 9), for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

As noted above, battery cells 120 have a variety of form factors, shapes, or sizes. For example, battery cells 120 may have a cylindrical, rectangular, square, cubic, flat, or prismatic form factor. FIGS. 7, 8, and 9 depict illustrative cross sectional views of battery cells 120 in such various form factors. For example, FIG. 8 is a cylindrical cell, FIG. 9 is a prismatic cell, and FIG. 10 is the cell for use in a pouch. The battery cells 120 may be assembled by inserting a wound or stacked electrode roll (e.g., a jellyroll) including a separator (e.g., polymeric sheet) or electrolyte material (e.g., solid state electrolyte) into at least one battery cell housing 230. The electrolyte material, e.g., an ionically conductive fluid or other material, may generate or provide electric power for the battery cell 120. In an embodiment, the separator is wetted by a liquid electrolyte during a liquid electrolyte filling operation after insertion of the jellyroll. A first portion of the electrolyte material may have a first polarity, and a second portion of the electrolyte material may have a second polarity. The housing 230 may be of various shapes, including cylindrical or rectangular, for example. Electrical connections may be made between the electrolyte material and components of the battery cell 120. For example, electrical connections with at least some of the electrolyte material may be formed at two points or areas of the battery cell 120, for example to form a first polarity terminal 235 (e.g., a positive or anode terminal) and a second polarity terminal 240 (e.g., a negative or cathode terminal). The polarity terminals may be made from electrically conductive materials to carry electrical current from the battery cell 120 to an electrical load, such as a component or system of the electric vehicle 105.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted), elliptical, or ovular base, among others. The shape of the housing 230 can also be prismatic with a polygonal base, such as a triangle, a square, a rectangle, a pentagon, and a hexagon, among others.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery cell 120 may include at least one anode layer 245, which may be disposed within the cavity 250 defined by the housing 230. The anode layer 245 may receive electrical current into the battery cell 120 and output electrons during the operation of the battery cell 120 (e.g., charging or discharging of the battery cell 120). The anode layer 245 may include an active sub stance.

The battery cell 120 may include at least one cathode layer 255 (e.g., a composite cathode layer compound cathode layer, a compound cathode, a composite cathode, or a cathode). The cathode layer 255 may be disposed within the cavity 250. The cathode layer 255 may output electrical current out from the battery cell 120 and may receive electrons during the discharging of the battery cell 120. The cathode layer 255 may also release lithium ions during the discharging of the battery cell 120. Conversely, the cathode layer 255 may receive electrical current into the battery cell 120 and may output electrons during the charging of the battery cell 120. The cathode layer 255 may receive lithium ions during the charging of the battery cell 120.

The battery cell 120 may include a polymer separator comprising a liquid electrolyte in the case of Li-ion batteries or a solid-state electrolyte layer 260 in the case of solid-state batteries, disposed within the cavity 250. The separator or solid-state electrolyte layer 260 may be arranged between the anode layer 245 and the cathode layer 255 to separate the anode layer 245 and the cathode layer 255. The liquid electrolyte or solid-state electrolyte layer 260 may transfer ions between the anode layer 245 and the cathode layer 255. The liquid or solid electrolytes can transfer cations (e.g., Li+ ions) from the anode layer 245 to the cathode layer 255 during a discharge operation of the battery cell 120. The liquid or solid electrolyte can transfer cations (e.g., Li+ ions) from the cathode layer 255 to the anode layer 245 during a charge operation of the battery cell 120.

FIG. 9 is an illustration of a prismatic battery cell 120. The prismatic battery cell 120 may have a housing 230 that defines a rigid enclosure. The housing 230 may have a polygonal base, such as a triangle, square, rectangle, pentagon, among others. For example, the housing 230 of the prismatic battery cell 120 may define a rectangular box. The prismatic battery cell 120 may include at least one anode layer 245, at least one cathode layer 255, and at least one separator and electrolyte or an electrolyte layer 260 disposed within the housing 230. The prismatic battery cell 120 may include a plurality of anode layers 245, cathode layers 255, and separator or electrolyte layers 260. For example, the layers 245, 255, 260 may be stacked or in a form of a flattened spiral. The prismatic battery cell 120 may include an anode tab 265. The anode tab 265 may contact the anode layer 245 and facilitate energy transfer between the prismatic battery cell 120 and an external component. For example, the anode tab 265 may exit the housing 230 or electrically couple with a positive terminal 235 to transfer energy between the prismatic battery cell 120 and an external component.

The battery cell 120 may also include a pressure vent 270. The pressure vent 270 may be disposed in the housing 230. The pressure vent 270 may provide pressure relief to the battery cell 120 as pressure increases within the battery cell 120. For example, gases may build up within the housing 230 of the battery cell 120. The pressure vent 270 may provide a path for the gases to exit the housing 230 when the pressure within the battery cell 120 reaches a threshold.

The present technology, thus generally described, will be understood more readily by reference to the following examples, which are provided by way of illustration and are not intended to be limiting of the present technology.

### EXAMPLES

General. First-principles density functional theory (DFT)-based methodologies can be used to determine, understand, and pre-select LiMPO₄ compounds for coating materials. The DFT algorithms are used calculate the thermodynamic stability of the materials, to identify those material shaving stable ground state structures vs. high-energy structures.

The screening strategy employed the following criteria to identify additional protective coating materials using LiMn_{0.1}Co_{0.1}Ni_{0.8}O₂ (NMC811) powders as an illustrative example of LiNMC materials more generally. The criteria included: (a) stability/synthesizability; (b) equilibrium with the NMC811 cathode material; and (c) electrolyte stability by predicting an equilibrium or no reaction with HF, LiF, and LiOH while scavenging corrosive species such as PF₅⁻.

In addition to LiMnPO₄, LiFePO₄, LiCoPO₄, LiNiPO₄, and LiSnPO₄, 18 additional Li-M-P-O compounds were identified that were thermodynamically stable as well as had predicted average voltage values greater than 4.3 V vs. Li/Li′. The thermodynamic stability is quantified based on the energy of the compound above the convex hull (Emu) in the chemical space of elements which make up the material and such data are readily acquired from the materials project database. A compound with Eₕᵤₗₗ=0 lies in the energy convex hull and is a thermodynamically stable phase at T=0 K. A compound with Eₕᵤₗₗ>0 is thermodynamically metastable and a material with a high energy above hull (e.g., >50 meV/atom) may have a strong driving force to decomposition and would be difficult to synthesize experimentally. Table 1 provides the 18 additional Li-M-P-O compounds identified to be thermodynamically stable according to the above-described parameters and, as predicted by DFT, have average voltage values of greater than 4.3 V vs. Li/Li⁺.

TABLE 1
Average Voltage Values vs. Li/Li⁺.

| | Average voltage vs. |
|---|---|
| Compound | Li/Li⁺ |
| LiV(PO₃)₄ | 4.71 |
| LiCrP₂O₇ | 4.69 |
| Li₃Mn₃(PO₄)₄ | 4.82 |
| LiMn(PO₃)₄ | 4.94 |
| Li₂MnP₂O₇ | 4.72 |
| LiMnP₂O₇ | 4.72 |
| Li₂FeP₂O₇ | 4.09 |
| LiFeP₂O₇ | 5.05 |
| Li₃Fe₂(PO₄)₃ | 4.76 |
| LiFe(PO₃)₄ | 4.67 |
| LiCo(PO₃)₄ | 6.19 |
| LiCo(PO₃)₃ | 5.25 |
| Li₂Ni₃(P₂O₇)₂ | 4.51 |
| LiNi(PO₃)₃ | 5.74 |
| Li₂CuP₂O₇ | 4.6 |
| LiCu(PO₃)₃ | 5.58 |
| LiMo(PO₄)₂ | 4.53 |
| LiBi(PO₃)₄ | 5.64 |

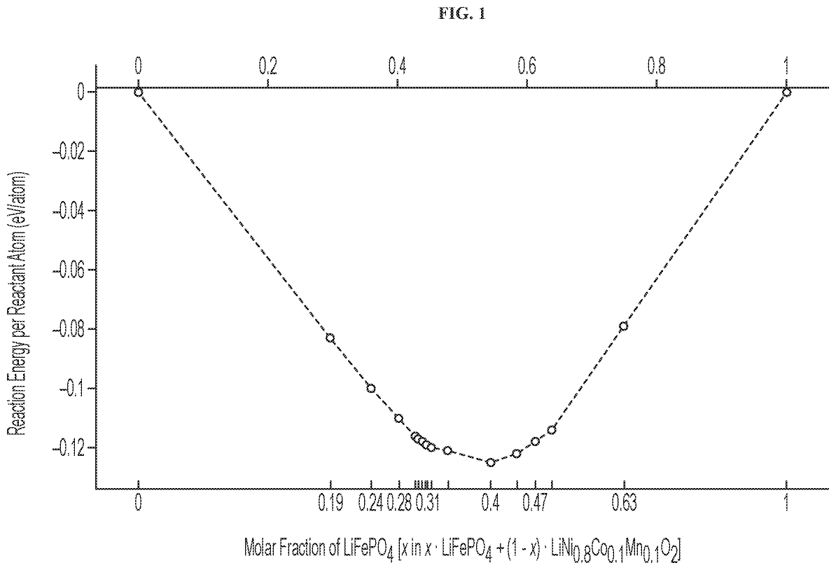

As noted above, another screening step included determining if the Li-M-P-O compounds exhibit chemical equilibrium with the NMC811 cathode material. It is preferred that either no reaction is found, or if there is a reaction it is at equilibrium so that overall compositional changes are not imparted to the electrode. To compute whether a compound exhibits equilibrium with the electrode materials, the convex hull method was used. For each candidate compound, the convex hull is calculated for the set of elements defined by the compound plus the electrolyte material. Within the convex hull, tie lines connecting the candidate compound with the electrolyte material are analyzed. The presence of a tie line is an indication that the candidate compound does exhibit stable equilibrium with the electrode. The absence of such a tie line indicates that the candidate compound does not exhibit stable equilibrium with the electrolyte but rather reacts. FIG. 1 shows the case study of utilizing LiFePO₄ as a coating material. The x-axis shows the molar fraction of NMC811, where x=0 is 100% NMC811 and x=1 is 100% LiFePO₄. The y-axis describes the reaction enthalpy in eV/atom. The most stable reaction between NMC811 and LiFePO₄.occurs when x=0.405. Accordingly, the graph in FIG. 1 shows that LiFePO₄ will react with NMC811, where the most energetically favorable chemical reaction is:

0.595 Li₁Mn_{0.1}Co_{0.1}Ni_{0.8}O₂+0.405 LiFePO₄→0.202 Fe₂NiO₄+0.012 Li₄MnCo₅O₁₂+0.14 LiNiPO₄+0.021 Mn(Ni₃O₄)₂+0.009 Li₂Mn₃NiO₈+0.265 Li₃PO₄

This reaction has a Eᵣₓₙ value of −0.125 eV/atom.

Similarly, Table 2 provides the performance of LiMnPO₄, LiFePO₄, LiCoPO₄, LiNiPO₄, LiSnPO₄, and those compounds listed in Table 1 with respect to generation of O₂, indicative of release of O₂ gas. When more than 0.05 O₂ is formed, these compounds are considered to have “high” O₂ evolution and thus may pose safety concerns.

TABLE 2
Generation of O₂ with NMC811.

| | | O₂ |
|---|---|---|
| Compound | Reaction with NMC811 | Evolution |
| LiMnPO₄ | 0.746 LiMn_{0.1}Co_{0.1}Ni_{0.8}O₂ + 0.254 LiMnPO₄ → 0.015 | None |
| | Li₄MnCo₅O₁₂ + 0.09 Li₂Mn₃NiO₈ + 0.045 Mn(Ni₃O₄)₂ + 0.239 | |
| | NiO + 0.254 Li₃PO₄ | |
| LiFePO₄ | 0.595 LiMn_{0.1}Co_{0.1}Ni_{0.8}O₂ + 0.405 LiFePO₄ → 0.202 Fe₂NiO₄ + | None |
| | 0.012 Li₄MnCo₅O₁₂ + 0.14 LiNiPO₄ + 0.021 Mn(Ni₃O₄)₂ + | |
| | 0.009 Li₂Mn₃NiO₈ + 0.265 Li₃PO₄ | |
| LiCoPO₄ | 0.698 LiMn_{0.1}Co_{0.1}Ni_{0.8}O₂ + 0.302 LiCoPO₄ → 0.186 Li(CoO₂)₂ + | None |
| | 0.07 Mn(Ni₃O₄)₂ + 0.047 LiNiPO₄ + 0.093 NiO + 0.256 | |
| | Li₃PO₄ | |
| LiNiPO₄ | 0.685 LiMn_{0.1}Co_{0.1}Ni_{0.8}O₂ + 0.315 LiNiPO₄ → 0.014 | Small |
| | Li₄MnCo₅O₁₂ + 0.178 Ni₃O₄ + 0.055 Mn(Ni₃O₄)₂ + 0.315 | |
| | Li₃PO₄ + 0.027 O₂ | |
| LiSnPO₄ | 0.667 LiMn_{0.1}Co_{0.1}Ni_{0.8}O₂ + 0.333 LiSnPO₄ → 0.233 SnO₂ + | None |
| | 0.033 Co₂SnO₄ + 0.533 NiO + 0.067 MnSnO₃ + 0.333 Li₃PO₄ | |
| LiV(PO₃)₄ | 0.826 LiMn_{0.1}Co_{0.1}Ni_{0.8}O₂ + 0.174 LiV(PO₃)₄ → 0.087 V₂NiO₆ + | Small |
| | 0.028 Li₂MnCo₃O₈ + 0.055 MnO₂ + 0.573 LiNiPO₄ + 0.124 | |
| | Li₃PO₄ + 0.05 O₂ | |
| LiCrP₂O₇ | 0.812 LiMn_{0.1}Co_{0.1}Ni_{0.8}O₂ + 0.188 LiCrP₂O₇ → 0.061 | None |
| | Mn(Ni₃O₄)₂ + 0.097 LiNiPO₄ + 0.016 Li₄MnCo₅O1₂ + 0.004 | |
| | LiMnCrO₄ + 0.184 CrNiO₄ + 0.278 Li₃PO₄ | |
| Li₃Mn₃(PO₄)₄ | 0.842 LiMn_{0.1}Co_{0.1}Ni_{0.8}O₂ + 0.158 Li₃Mn₃(PO₄)₄ → 0.028 | Small |
| | Li₂MnCo₃O₈ + 0.177 Li₂Mn₃NiO₈ + 0.496 LiNiPO₄ + 0.137 | |
| | Li₃PO₄ + 0.022 O₂ | |
| LiMn(PO₃)₄ | 0.835 LiMn_{0.1}Co_{0.1}Ni_{0.8}O₂ + 0.165 LiMn(PO₃)₄ → 0.028 | High |
| | Li₂MnCo₃O₈ + 0.074 Li₂Mn₃NiO₈ + 0.594 LiNiPO₄ + 0.068 | |
| | Li₃PO₄ + 0.098 O₂ | |
| Li₂MnP₂O₇ | 0.746 LiMn_{0.1}Co_{0.1}Ni_{0.8}O₂ + 0.254 Li₂MnP₂O₇ → 0.015 | None |
| | Li₄MnCo₅O₁₂ + 0.09 Li₂Mn₃NiO₈ + 0.042 Mn(Ni₃O₄)₂ + 0.255 | |
| | LiNiPO₄ + 0.253 Li₃PO₄ | |
| LiMnP₂O₇ | 0.722 LiMn_{0.1}Co_{0.1}Ni_{0.8}O₂ + 0.278 LiMnP₂O₇ → 0.024 | High |
| | Li₂MnCo₃O₈ + 0.109 Li₂Mn₃NiO₈ + 0.468 LiNiPO₄ + 0.089 | |
| | Li₃PO₄ + 0.051 O₂ | |
| Li₂FeP₂O₇ | 0.672 LiMn_{0.1}Co_{0.1}Ni_{0.8}O₂ + 0.328 Li₂FeP₂O₇ → 0.022 | Small |
| | Li₂MnCo₃O₈ + 0.164 Fe₂NiO₄ + 0.358 LiNiPO₄ + 0.015 | |
| | Li₂Mn₃NiO₈ + 0.299 Li₃PO₄ + 0.03 O₂ | |
| LiFeP₂O₇ | 0.816 LiMn_{0.1}Co_{0.1}Ni_{0.8}O₂ + 0.184 LiFeP₂O₇ → 0.092 Fe₂NiO₄ + | High |
| | 0.071 LiNiPO₄ + 0.041 Li(CoO₂)₂ + 0.082 Mn(Ni₃O₄)₂ + 0.296 | |
| | Li₃PO₄ + 0.133 O₂ | |
| Li₃Fe₂(PO₄)₃ | 0.856 LiMn_{0.1}Co_{0.1}Ni_{0.8}O₂ + 0.144 Li₃Fe₂(PO₄)₃ → 0.144 | High |
| | Fe₂NiO₄ + 0.027 LiNiPO₄ + 0.043 Li(CoO₂)₂ + 0.086 | |
| | Mn(Ni₃O₄)₂ + 0.406 Li₃PO₄ + 0.139 O₂ | |
| LiFe(PO₃)₄ | 0.818 LiMn_{0.1}Co_{0.1}Ni_{0.8}O₂ + 0.182 LiFe(PO₃)₄ → 0.027 | High |
| | Li₂MnCo₃O₈ + 0.636 LiNiPO₄ + 0.018 Li₂Mn₃NiO₈ + 0.091 | |
| | Fe₂O₃ + 0.091 Li₃PO₄ + 0.136 O₂ | |
| LiCo(PO₃)₄ | 0.821 LiMn_{0.1}Co_{0.1}Ni_{0.8}O₂ + LiCo(PO₃)₄ → 0.082 Li₂MnCo₃O₈ + | High |
| | 0.015 CoO₂ + 0.657 LiNiPO₄ + 0.06 Li₃PO₄ + 0.119 O₂ | |
| LiCo(PO₃)₃ | 0.773 LiMn_{0.1}Co_{0.1}Ni_{0.8}O₂ + 0.227 LiCo(PO₃)₃ → 0.036 | Small |
| | Li(CoO₂)₂ + 0.077 Li₂MnCo₃O₈ + 0.618 LiNiPO₄ + 0.064 | |
| | Li₃PO₄ + 0.05 O₂ | |
| Li₂Ni₃(P₂O₇)₂ | 0.913 LiMn_{0.1}Co_{0.1}Ni_{0.8}O₂ + 0.087 Li₂Ni₃(P₂O₇)₂ → 0.046 | High |
| | Li(CoO₂)₂ + 0.148 Ni₃O₄ + 0.091 Mn(Ni₃O₄)₂ + 0.347 Li₃PO₄ + | |
| | 0.075 O₂ | |
| LiNi(PO₃)₃ | 0.711 LiMn_{0.1}Co_{0.1}Ni_{0.8}O₂ + 0.289 LiNi(PO₃)₃ → 0.024 | High |
| | Li₂MnCo₃O₈ + 0.016 Li₂Mn₃NiO₈ + 0.842 LiNiPO₄ + 0.026 | |
| | Li₃PO₄ + 0.118 O₂ | |
| Li₂CuP₂O₇ | 0.808 LiMn_{0.1}Co_{0.1}Ni_{0.8}O₂ + 0.192 Li₂CuP₂O₇ → 0.081 | High |
| | Mn(Ni₃O₄)₂ + 0.04 Li(CoO₂)₂ + 0.054 Ni₃O₄ + 0.096 Cu₂O₃ + | |
| | 0.384 Li₃PO₄ + 0.056 O₂ | |
| LiCu(PO₃)₃ | 0.759 LiMn_{0.1}Co_{0.1}Ni_{0.8}O₂ + 0.241 LiCu(PO₃)₃ → 0.608 LiNiPO₄ + | High |
| | 0.025 Li₂MnCo₃O₈ + 0.051 MnO₂ + 0.12 Cu₂O₃ + 0.114 | |
| | Li₃PO₄ + 0.066 O₂ | |
| LiMo(PO₄)₂ | 0.741 LiMn_{0.1}Co_{0.1}Ni_{0.8}O₂ + 0.259 LiMo(PO₄)₂ → 0.016 | High |
| | Li₂Mn₃NiO₈ + 0.025 Li₂MnCo₃O₈ + 0.518 LiNiPO₄ + 0.059 | |
| | NiMoO₄ + 0.2 Li₂MoO₄ + 0.059 O₂ | |
| LiBi(PO₃)₄ | 0.766 LiMn_{0.1}Co_{0.1}Ni_{0.8}O₂ + 0.234 LiBi(PO₃)₄ → 0.234 BiPO₄ + | High |
| | 0.026 Li₂MnCo₃O8 + 0.596 LiNiPO₄ + 0.017 Li₂Mn₃NiO₈ + | |
| | 0.106 Li₃PO₄ + 0.128 O₂ | |

LiFePO₄ is a known coating material for Li-ion battery cathode powders, and is generally considered to provide a stable protective layer. Accordingly, Table 3 provides the stability of the Li-M-P-O compounds that do not release or release less than 0.05 O₂ as determined with respect to NMC811, and this was then normalized to the case of LiFePO₄. In the Table, LiMnPO₄ has a ratio for LiMnPO₄:NMC811 (“Ratio”) of 0.34, and a “Ratio vs LiFePO₄” of 0.50. For NMC811 reaction, it is beneficial if the “Ratio” value of the coating is lower when compared to that of LiFePO₄:NMC811, or in other words, the coating consumes less NMC811 than LiFePO₄. Similarly, it is desirable that the Eᵣₓₙ of NMC811 versus the compound be higher (i.e., less favorable to react with NMC811) compared to NMC811 vs. LiFePO₄ reaction. The Eᵣₓₙ of the screened Li-M-P-O coatings vs. LiFePO₄ is presented in the column marked “Eᵣₓₙ vs. LiFePO₄.”

The two values that are referenced to LiFePO₄ for molar ratio and reaction enthalpy are then added (“Sum”). Because these values are evaluated based on the molar fraction, they are then converted by dividing by molecular weight: e.g., 2.00/157.76×1,000=12.68 for LiFePO₄. In the last column (the ‘NMC811 stability score’), the percentage improvement vs. LiFePO₄ is provided. For example, for LiMnPO₄, the calculation is: 12.68/9.62×100=131.84%. An “NMC811 stability score” >100 indicates that the Li-M-P-O compound is expected to have better stability with regard to NMC811, compared to LiFePO₄. All compounds listed in Table 3 exhibit better performance for NMC811 stability, when compared with the state-of-art LiFePO₄ material.

TABLE 3
Evaluation of Li—M—P—O chemical stability with NMC811 for
compounds that do not release O₂ or release less than 0.05 O₂.

| | | | | | | | NMC811 |
|---|---|---|---|---|---|---|---|
| | MW | | Ratio vs. | Eᵣₓₙ | Eᵣₓₙ vs. | | stability |
| Compound | (g/mol) | Ratio | LiFePO₄ | (eV/atom) | LiFePO₄ | Sum | score |
| LiMnPO₄ | 156.85 | 0.34 | 0.50 | −0.126 | 1.01 | 1.51 | 131.84 |
| LiFePO₄ | 157.76 | 0.68 | 1.00 | −0.125 | 1.00 | 2.00 | 100.00 |
| LiCoPO₄ | 160.85 | 0.43 | 0.64 | −0.086 | 0.69 | 1.32 | 154.06 |
| LiNiPO₄ | 160.61 | 0.46 | 0.68 | −0.049 | 0.39 | 1.07 | 190.72 |
| LiSnPO₄ | 220.62 | 0.50 | 0.73 | −0.224 | 1.79 | 2.53 | 110.75 |
| LiV(PO₃)₄ | 373.77 | 0.21 | 0.31 | −0.170 | 1.36 | 1.67 | 283.83 |
| LiCrP₂O₇ | 232.88 | 0.23 | 0.34 | −0.111 | 0.89 | 1.23 | 240.39 |
| Li₃Mn₃(PO₄)₄ | 565.52 | 0.19 | 0.28 | −0.112 | 0.90 | 1.17 | 611.89 |
| Li₂MnP₂O₇ | 242.76 | 0.34 | 0.50 | −0.120 | 0.96 | 1.46 | 210.76 |
| Li₂FeP₂O₇ | 243.67 | 0.49 | 0.72 | −0.115 | 0.92 | 1.64 | 188.70 |
| LiCo(PO₃)₃ | 302.79 | 0.29 | 0.20 | −0.140 | 1.12 | 1.55 | 247.42 |

HF can form in the liquid electrolyte when residual water/moisture is present to react with LiPF₆ salt in the battery cell: LiPF₆+H₂O₄↔POF₃+2HF+LiF. HF is an acid that can degrade subcomponents in battery cell. In particular, NMC811 cathode may react with HF in at least molar factions of 0.083-0.714 to decompose the NMC811 cathode material to other species and consequently reducing the cathode material's capacity to (de-)insert Li ions.

Therefore, it would be beneficial for a Li-M-P-O coating to scavenge HF as much as possible. Accordingly, the HF reactivity for 11 Li-M-P-O compounds was determined and this was then normalized to the case of LiFePO₄, where the results are provided in Table 4. In particular, 0.077 LiFePO₄ reacts with 0.923 HF to yield 0.308 H₃OF, 0.077 LiPF₆, and 0.077 FeF₂ with Eᵣₓₙ of −0.156 eV/atom. It would be beneficial for a Li-M-P-O coating to scavenge HF more effectively than LiFePO₄, where the “Ratio” between HF to Li-M-P-O is higher than the ratio of HF to LiFePO₄. In particular, HF:LiFePO₄ is 0.923:0.77=11.99, where all other Li-M-P-O materials are normalized vs. LiFePO₄ in the “Ratio vs. LiFePO₄” column. An example is LiV(PO₃)₄, where HF:LiV(PO₃)₄=36.04, and the “Ratio vs. LiFePO₄” is 11.99/36.04=0.33. It is beneficial when the “Ratio vs. LiFePO₄” is less than 1 (i.e., more reactive against HF). Another criteria is the reaction enthalpy. When LiFePO₄ reacts with HF, the corresponding reaction enthalpy (Eᵣₓₙ) is found to be −0.156 eV/atom. The reaction enthalpy for the Li-M-P-O materials was normalized vs. LiFePO₄ (“Eᵣₓₙ vs. LiFePO₄”) where it is beneficial when this value is less than 1 (i.e., HF scavenging reaction is more favorable). The two values that are referenced to LiFePO₄ for molar ratio and reaction enthalpy are then added (“Sum”). Since these values are evaluated based on the molar fraction, we then convert this value by dividing my molecular weight: e.g., 2.00/157.76×1,000=12.68 for LiFePO₄. Lastly, the “HF score” provides the improvement vs. LiFePO₄ for all materials: 12.68/12.67×100=100.06% for LiMnPO₄. As illustrated in Table 4, all Li-M-P-O compounds showed improved performance for HF scavenging reactions when compared with the LiFePO₄ material, with the exception of LiCoPO₄.

TABLE 4
HF reactivity with Li—M—P—O compounds.

| | | | Ratio vs. | | Eᵣₓₙ vs. | | HF |
|---|---|---|---|---|---|---|---|
| Li—M—P—O | Reaction with HF | Ratio | LiFePO₄ | Eᵣₓₙ | LiFePO₄ | Sum | score |
| LiMnPO₄ | 0.923 HF + 0.077 LiMnPO₄ → 0.308 H₃OF + | 11.99 | 1.00 | −0.158 | 0.99 | 1.99 | 100.06 |
| | 0.077 LiPF₆ + 0.077 MnF₂ | | | | | | |
| LiFePO₄ | 0.077 LiFePO₄ + 0.923 HF → 0.308 H₃OF + | 11.99 | 1.00 | −0.156 | 1.00 | 2.00 | 100.00 |
| | 0.077 LiPF₆ + 0.077 FeF₂ | | | | | | |
| LiCoPO₄ | 0.923 HF + 0.077 LiCoPO₄ → 0.077 LiPF₆ + | 11.99 | 1.00 | −0.149 | 1.05 | 2.05 | 99.62 |
| | 0.308 H₃OF + 0.077 CoF₂ | | | | | | |
| LiNiPO₄ | 0.923 HF + 0.077 LiNiPO₄ → 0.077 LiPF₆ + | 11.99 | 1.00 | −0.155 | 1.01 | 2.01 | 101.48 |
| | 0.308 H₃OF + 0.077 NiF₂ | | | | | | |
| LiSnPO₄ | 0.077 LiSnPO₄ + 0.923 HF → 0.308 H₃OF + | 11.99 | 1.00 | −0.156 | 1.00 | 2.00 | 139.85 |
| | 0.077 SnF₂ + 0.077 LiPF₆ | | | | | | |
| LiV(PO₃)₄ | 0.973 HF + 0.027 LiV(PO₃)₄ → 0.324 H₃OF + | 36.04 | 0.33 | −0.133 | 1.17 | 1.51 | 314.73 |
| | 0.027 LiPF₆ + 0.081 PF₅ + 0.027 VF₃ | | | | | | |
| LiCrP₂O₇ | 0.955 HF + 0.045 LiCrP₂O₇ → 0.318 H₃OF + | 21.22 | 0.56 | −0.137 | 1.14 | 1.70 | 173.31 |
| | 0.045 LiPF₆ + 0.045 PF₅ + 0.045 CrF₃ | | | | | | |
| Li₃Mn₃(PO₄)₄ | 0.98 HF + 0.02 Li₃Mn₃(PO₄)₄ → 0.327 H₃OF + | 49.00 | 0.24 | −0.148 | 1.05 | 1.30 | 552.05 |
| | 0.061 LiPF₆ + 0.061 MnF₃ + 0.02 PF₅ | | | | | | |
| Li₂MnP₂O₇ | 0.955 HF + 0.045 Li₂MnP₂O₇ → 0.318 H₃OF + | 21.22 | 0.56 | −0.151 | 1.03 | 1.60 | 192.60 |
| | 0.091 LiPF₆ + 0.045 MnF₂ | | | | | | |
| Li₂FeP₂O₇ | 0.045 Li₂FeP₂O₇ + 0.955 HF → 0.318 H₃OF + | 21.22 | 0.56 | −0.150 | 1.04 | 1.60 | 192.49 |
| | 0.091 LiPF₆ + 0.045 FeF₂ | | | | | | |
| LiCo(PO₃)₃ | 0.964 HF + 0.036 LiCo(PO₃)₃ → 0.036 LiPF₆ + | 26.78 | 0.45 | −0.134 | 1.16 | 1.61 | 300.27 |
| | 0.321 H₃OF + 0.036 CoF₂ + 0.071 PF₅ | | | | | | |

PF₅⁻ is a species that forms from LiPF₆ salt decomposition: LiPF₆↔LiF+PF₅⁻. Similar to HF, PF₅⁻ will decompose NMC811. Therefore, it is beneficial if the Li-M-P-O coating materials scavenge PF₅⁻. Thus, similar to the determination of HF reactivity, the PF₅⁻ reactivity for 11 Li-M-P-O compounds was determined and this was then normalized to the case of LiFePO₄ to provide a “PF₅ score,” where the results are provided in Table 5. As shown in this Table, LiSnPO₄, LiCrP₂O₇, Li₃Mn₃(PO₄)₄, LiMnP₂O₇, and Li₂FeP₂O₇ favorably react against PF₅⁻ (as compared to LiFePO₄).

TABLE 5
PF₅⁻ reactivity with Li—M—P—O compounds.

| | | | Ratio vs. | | Eᵣₓₙ vs. | | |
|---|---|---|---|---|---|---|---|
| Li—M—P—O | Reaction with PF₅ | Ratio | LiFePO₄ | Eᵣₓₙ | LiFePO₄ | Sum | PF₅ |
| LiMnPO₄ | 0.571 PF₅ + 0.429 LiMnPO₄ → 0.286 Mn(PO₃)₂ + | 0.75 | 1.77 | −0.071 | 0.94 | 2.72 | 73.23 |
| | 0.429 LiPF₆ + 0.143 MnF₂ | | | | | | |
| LiFePO₄ | 0.429 LiFePO₄ + 0.571 PF₅ → 0.286 Fe(PO₃)₂ + | 1.33 | 1.00 | −0.067 | 1.00 | 2.00 | 100.00 |
| | 0.143 FeF₂ + 0.429 LiPF₆ | | | | | | |
| LiCoPO₄ | 0.471 PF₅ + 0.529 LiCoPO₄ → 0.235 LiCo(PO₃)₃ + | 0.89 | 1.49 | −0.046 | 1.46 | 2.95 | 69.09 |
| | 0.294 LiPF₆ + 0.294 CoF₂ | | | | | | |
| LiNiPO₄ | 0.571 PF₅ + 0.429 LiNiPO₄ → 0.429 LiPF₆ + | 0.75 | 1.77 | −0.067 | 1.00 | 2.77 | 73.46 |
| | 0.286 Ni(PO₃)₂ + 0.143 NiF₂ | | | | | | |
| LiSnPO₄ | 0.5 LiSnPO₄ + 0.5 PF₅ → 0.5 SnPO₃F + 0.333 | 1.00 | 1.33 | −0.071 | 0.94 | 2.27 | 122.96 |
| | LiPF₆ + 0.167 LiPO₃ | | | | | | |
| LiV(PO₃)₄ | 0.667 PF₅ + 0.333 LiV(PO₃)₄ → 0.333 V(PO₃)₃ + | 2.00 | 0.67 | −0.010 | 6.70 | 7.37 | 64.33 |
| | 0.333 P₂O₃F₄ + 0.333 LiPF₆ | | | | | | |
| LiCrP₂O₇ | 0.571 PF₅ + 0.429 LiCrP₂O₇ → 0.333 Cr(PO₃)₃ + | 1.33 | 1.00 | −0.038 | 1.76 | 2.76 | 106.85 |
| | 0.095 CrF₃ + 0.429 LiPF₆ | | | | | | |
| Li₃Mn₃(PO₄)₄ | 0.571 PF₅ + 0.429 Li₃Mn₃(PO₄)₄ → 0.571 | 1.33 | 1.00 | −0.053 | 1.26 | 2.26 | 316.65 |
| | LiMn(PO3)4 + 0.714 LiMnF₄ | | | | | | |
| Li₂MnP₂O₇ | 0.667 PF₅ + 0.333 Li₂MnP₂O₇ → 0.333 Mn(PO₃)₂ + | 2.00 | 0.67 | −0.054 | 1.24 | 1.91 | 161.45 |
| | 0.111 LiPO₃ + 0.556 LiPF₆ | | | | | | |
| Li₂FeP₂O₇ | 0.333 Li₂FeP₂O₇ + 0.667 PF₅ → 0.333 Fe(PO₃)₂ + | 2.00 | 0.67 | −0.053 | 1.26 | 1.93 | 160.09 |
| | 0.556 LiPF₆ + 0.111 LiPO₃ | | | | | | |
| LiCo(PO₃)₃ | 0.8 PF₅ + 0.2 LiCo(PO₃)₃ → 0.2 LiPF₆ + 0.6 | 4.00 | 0.33 | −0.004 | 16.75 | 17.08 | 28.33 |
| | P₂O₃F₄ + 0.2 CoF₂ | | | | | | |

Electrolyte decomposition leads to the formation of the desirable solid electrolyte interface (SEI). The SEI is primarily composed of LiF, Li₂O, Li₂CO₃ and other insoluble products. Enriching the SEI with LiF has recently gained popularity to improve Li cyclability. Here, it is desirable that the Li-M-P-O coatings not to consume LiF, so that it remains available for the SEI formation. LiOH may also be present at the surface of cathode materials, depending on the choice of Li salt precursors. The presence of LiOH leads to the formation of H₂O within the cell, and this can subsequently form HF. Similar to LiF, it is desirable that the LiOH reaction not take place when in contact with the Li-M-P-O compounds, to avoid the H₂O formation.

Similar to the determination of HF reactivity and PF₅⁻ reactivity discussed above, the LiF reactivity and LiOH reactivity for 11 Li-M-P-O compounds was determined. For the LiF reactivity, LiFePO₄ was found not to react with LiF, therefore the LiF reactivity was determined and then normalized to the case of LiMnPO₄ to ultimately provide a “LiF score” as illustrated in Table 6. For the LiF reactivity, it is beneficial if “Ratio” value is lower (i.e., less reaction with LiF) and for the Eᵣₓₙ to be higher (i.e., less favorable to react with LiF). LiCoPO₄, LiNiPO₄, LiSnPO₄, Li₂MnP₂O₇, Li₂FeP₂O₇, and LiCo(PO₃)₃ were determined to be stable in contact with LiF. For LiOH reactivity, as indicated in Table 7, determinations were made for the indicated Li-M-P-O compounds then normalized to the case of LiFePO₄ to provide a “LiOH score.” LiMnPO₄, LiSnPO₄, and Li₃Mn₃(PO₄)₄ were found to be most stable against LiOH.

TABLE 6
LiF reactivity with Li—M—P—O compounds.

| | | | Ratio vs. | | Eᵣₓₙ vs. | | |
|---|---|---|---|---|---|---|---|
| Li—M—P—O | LiF reactions | Ratio | LiMnPO₄ | Eᵣₓₙ | LiMnPO₄ | Sum | LiF |
| LiMnPO₄ | 0.333 LiF + 0.667 LiMnPO₄ → 0.333 Li₃PO₄ + 0.333 | 0.50 | 1.00 | −0.003 | 1.00 | 2.00 | 100.00 |
| | Mn₂PO₄F | | | | | | |
| LiFePO₄ | No reaction | N/A | N/A | N/A | N/A | N/A | N/A |
| LiCoPO₄ | No reaction | N/A | N/A | N/A | N/A | N/A | N/A |
| LiNiPO₄ | No reaction | N/A | N/A | N/A | N/A | N/A | N/A |
| LiSnPO₄ | No reaction | N/A | N/A | N/A | N/A | N/A | N/A |
| LiV(PO₃)₄ | 0.143 LiV(PO₃)₄ + 0.857 LiF → 0.571 LiPO₃ + 0.143 Li₃VF₆ | 5.99 | 11.99 | −0.008 | 2.67 | 14.65 | 32.53 |
| LiCrP₂O₇ | 0.571 Li₂VCrP₃O₁₀ + 0.429 LiF → 0.143 VP + 0.571 | 0.75 | 1.50 | −0.007 | 2.33 | 3.84 | 77.41 |
| | Li₂CrP₂O₇ + 0.429 LiVPO₄F | | | | | | |
| Li₃Mn₃(PO₄)₄ | 0.75 LiF + 0.25 Li₃Mn₃(PO₄)₄ → 0.75 LiMnPO₄F + 0.25 | 3.00 | 6.00 | −0.003 | 1.00 | 7.00 | 103.01 |
| | Li₃PO₄ | | | | | | |
| Li₂MnP₂O₇ | No reaction | N/A | N/A | N/A | N/A | N/A | N/A |
| Li₂FeP₂O₇ | No reaction | N/A | N/A | N/A | N/A | N/A | N/A |
| LiCo(PO₃)₃ | No reaction | N/A | N/A | N/A | N/A | N/A | N/A |

TABLE 7
LiOH reactivity with Li—M—P—O compounds.

| | | | Ratio vs. | | Eᵣₓₙ vs. | | |
|---|---|---|---|---|---|---|---|
| Li—M—P—O | LiOH reactions | Ratio | LiFePO₄ | Eᵣₓₙ | LiFePO₄ | Sum | LiOH |
| LiMnPO₄ | 0.667 LiHO + 0.333 LiMnPO₄ → 0.333 MnO + 0.333 Li₃PO₄ + | 2.00 | 1.00 | −0.048 | 0.89 | 1.89 | 105.27 |
| | 0.333 H₂O | | | | | | |
| LiFePO₄ | 0.333 LiFePO₄ + 0.667 LiHO → 0.333 FeO + 0.333 Li₃PO₄ + | 2.00 | 1.00 | −0.054 | 1.00 | 2.00 | 100.00 |
| | 0.333 H₂O | | | | | | |
| LiCOPO₄ | 0.667 LiHO + 0.333 LiCoPO₄ → 0.333 CoO + 0.333 Li₃PO₄ + | 2.00 | 1.00 | −0.062 | 1.15 | 2.15 | 94.93 |
| | 0.333 H₂O | | | | | | |
| LiNiPO₄ | 0.667 LiHO + 0.333 LiNiPO₄ → 0.333 NiO + 0.333 Li₃PO₄ + | 2.00 | 1.00 | −0.075 | 1.39 | 2.39 | 85.23 |
| | 0.333 H₂O | | | | | | |
| LiSnPO₄ | 0.333 LiSnPO₄ + 0.667 LiHO → 0.333 SnO + 0.333 Li₃PO₄ + | 2.00 | 1.00 | −0.082 | 1.52 | 2.52 | 111.05 |
| | 0.333 H₂O | | | | | | |
| LiV(PO₃)₄ | 0.917 LiHO + 0.083 LiV(PO₃)₄ → 0.083 VHO₂ + 0.333 | 11.05 | 5.52 | −0.163 | 3.02 | 8.54 | 55.47 |
| | Li₃PO₄ + 0.417 H₂O | | | | | | |
| LiCrP₂O₇ | 0.167 LiCrP₂O₇ + 0.833 LiHO → 0.167 CrHO₂ + 0.333 | 4.99 | 2.49 | −0.129 | 2.39 | 4.88 | 60.46 |
| | Li₃PO₄ + 0.333 H₂O | | | | | | |
| Li₃Mn₃(PO₄)₄ | 0.9 LiHO + 0.1 Li₃Mn₃(PO₄)₄ → 0.15 Mn₂O₃ + 0.4 Li₃PO₄ + | 9.00 | 4.50 | −0.114 | 2.11 | 6.61 | 108.44 |
| | 0.45 H₂O | | | | | | |
| Li₂MnP₂O₇ | 0.8 LiHO + 0.2 Li₂MnP₂O₇ → 0.2 MnO + 0.4 Li₃PO₄ + 0.4 | 4.00 | 2.00 | −0.088 | 1.63 | 3.63 | 84.79 |
| | H₂O | | | | | | |
| Li₂FeP₂O₇ | 0.2 Li₂FeP₂O₇ + 0.8 LiHO → 0.2 FeO + 0.4 Li₃PO₄ + 0.4 | 4.00 | 2.00 | −0.092 | 1.70 | 3.70 | 83.41 |
| | H₂O | | | | | | |
| LiCo(PO₃)₃ | 0.857 LiHO + 0.143 LiCo(PO₃)₃ → 0.143 LiCoPO₄ + 0.286 | 5.99 | 3.00 | −0.159 | 2.94 | 5.94 | 81.46 |
| | Li₃PO₄ + 0.429 H₂O | | | | | | |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or devices, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrode composition comprising a particulate bulk cathode active material comprising a lithium transition metal phosphorous oxide coating on a surface of the particulate bulk cathode active material; wherein the particulate bulk cathode active material has a layered-type structure.

2. The electrode composition of claim 1, wherein the lithium transition metal phosphorous oxide coating comprises:
a greater NMC811 stability score when normalized to that of LiFePO₄ at 100%; or
a greater HF score when normalized to that of LiFePO₄ at 100%; or
a combination thereof.

3. The electrode composition of claim 1, wherein the lithium transition metal phosphorous oxide comprises LiMnPO₄, LiV(PO₃)₄, or a mixture thereof.

4. The electrode composition of claim 1, wherein the lithium transition metal phosphorous oxide comprises LiNiPO₄, LiCrP₂O₇, Li₂MnP₂O₇, Li₂FeP₂O₇, LiCo(PO₃)₃, or a mixture of any two or more thereof.

5. The electrode composition of claim 1, wherein the lithium transition metal phosphorous oxide comprises LiCoPO₄, LiSnPO₄, Li₃Mn₃(PO₄)₄, or a mixture of any two or more thereof.

6. The electrode composition of claim 1, wherein the lithium transition metal phosphorous oxide coating comprises a lithium transition metal phosphorous oxide other than LiFePO₄.

7. The electrode composition of claim 6, wherein the coating further comprises LiFePO₄.

8. The electrode composition of claim 1, wherein the particulate bulk cathode active material is a nickel-rich cathode active material, having greater than 70 wt % nickel.

9. The electrode composition of claim 1, wherein the particulate bulk cathode active material is a lithium nickel-manganese-cobalt oxide (“LiNMC”) cathode material.

10. The electrode composition of claim 1, wherein the particulate bulk cathode active material is LiCoO₂, Li(NiₐMn_{b}Co_{c})O₂, or Li(Mn_{α}Ni_{β})₂O₄, wherein a+b+c=1, and α+β=1.

11. The electrode composition of claim 1, wherein the lithium transition metal phosphorous oxide comprises a redox voltage greater than 4V.

12. The electrode composition of claim 1, wherein the lithium transition metal phosphorous oxide coating has an olivine-type structure.

13. The electrode composition of claim 1, wherein the coating comprises a first coating material on the surface of the particulate bulk cathode active material and a second coating material overcoating the first coating material, wherein:
the first coating material, the second coating material, or both the first coating material and second coating material comprise the lithium transition metal phosphorous oxide.

14. The electrode composition of claim 1, wherein the first coating material comprises LiFePO₄, and the second coating material comprises LiMnPO₄, LiCoPO₄, LiNiPO₄, LiSnPO₄, LiV(PO₃)₄, LiCrP₂O₇, Li₃Mn₃(PO₄)₄, Li₂MnP₂O₇, Li₂FeP₂O₇, LiCo(PO₃)₃, or a mixture of any two or more thereof.

15. The electrode composition of claim 1, wherein the lithium transition metal phosphorous oxide coating comprises a redox voltage greater than LiFePO₄, LiMnPO₄, or a combination of LiFePO₄ and LiMnPO₄.

16. The electrode composition of claim 1, wherein the lithium transition metal phosphorous oxide coating comprises a dopant, wherein the dopant increases a de-lithiation voltage of the coating relative to the coating without the dopant.

17. A lithium ion battery comprising:
a cathode comprising a particulate bulk cathode active material and a current collector; wherein:
one or more of the cathode active material or the current collector is at least partially coated with a lithium transition metal phosphorous oxide.

18. The lithium ion battery of claim 17, wherein the lithium transition metal phosphorous oxide coating comprises:
a greater NMC811 stability score when normalized to that of LiFePO₄ at 100%; or
a greater HF score when normalized to that of LiFePO₄ at 100%; or
a combination thereof.

19. The lithium ion battery of claim 17, wherein the lithium transition metal phosphorous oxide comprises LiMnPO₄, LiCoPO₄, LiNiPO₄, LiSnPO₄, LiV(PO₃)₄, LiCrP₂O₇, Li₃Mn₃(PO₄)₄, Li₂MnP₂O₇, Li₂FeP₂O₇, LiCo(PO₃)₃, or a mixture of any two or more thereof.

20. A process of manufacturing a cathode for a lithium ion battery, the process comprising:
mixing an electrode composition of claim 1 with conductive carbon and a binder in a solvent to form a slurry;
coating the slurry onto a cathode current collector, and
removing the solvent.
